(19) United States
(12) Patent Application Publication
(10) Pub. No.: US 2013/0271067 A1
(43) Pub. Date: Oct. 17, 2013

(54) PORTABLE CHARGER

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventors: LONG YU, Shenzhen (CN); YAN-BIN LIU, Shenzhen (CN); JIN-XIN WANG, Shenzhen (CN); TANG LI, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 13/854,234

(22) Filed: Apr. 1, 2013

(30) Foreign Application Priority Data
Apr. 17, 2012 (CN) 201210111968.2

(51) Int. Cl. H02J 7/00

(52) U.S. Cl. CPC H02J 7/0044
USPC 320/107

(57) ABSTRACT

A portable charger includes a main body, an electrically connecting mechanism, and a charging module. The main body includes a receiving body and a support seat extending from one side of the receiving body and bent substantially perpendicularly from the receiving body. The electrically connecting mechanism includes a connecting member movably mounted on the support seat. The charging module includes a storage member received in the receiving body and at least one interface electrically connected to the storage member. The storage member is electrically connected to the connecting member.

### BACKGROUND

1. Technical Field

The present disclosure relates to chargers, and particularly to a portable charger for use with portable electronic devices.

2. Description of the Related Art

Batteries provide the electrical power required by the portable electronic devices such as mobile phones, tablet computers, and notebook computers. When the batteries are out of electric power, a fixed or directly wired power source is needed to charge the batteries. Thus, it may be inconvenient for a user to charge the batteries of the portable electronic devices when travelling.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is an assembled, isometric view of a portable charger of one embodiment, including an electrically connecting mechanism.

FIG. 2 is an exploded, isometric view of the portable charger in FIG. 1.

FIG. 3 is an exploded, isometric view of the electrically connecting mechanism in FIG. 1.

FIG. 4 is an assembled, isometric view of the electrically connecting mechanism in FIG. 3.

FIG. 5 shows a usage state of the portable charger for an electronic device in FIG. 1.

FIG. 6 is a partial, cross sectional view of the portable charger along line VI-VI in FIG. 5.

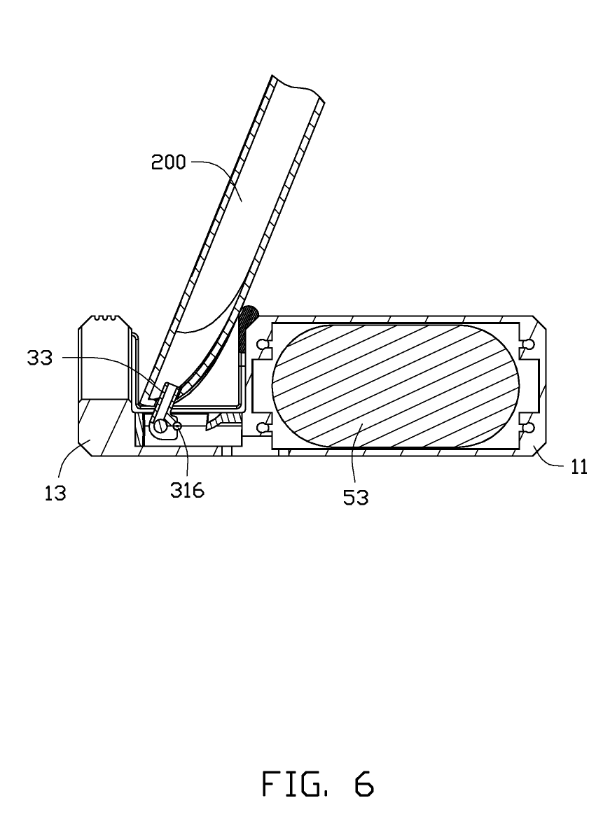

FIG. 7 shows another usage state of the portable charger for the electronic device in FIG. 1.

### DETAILED DESCRIPTION

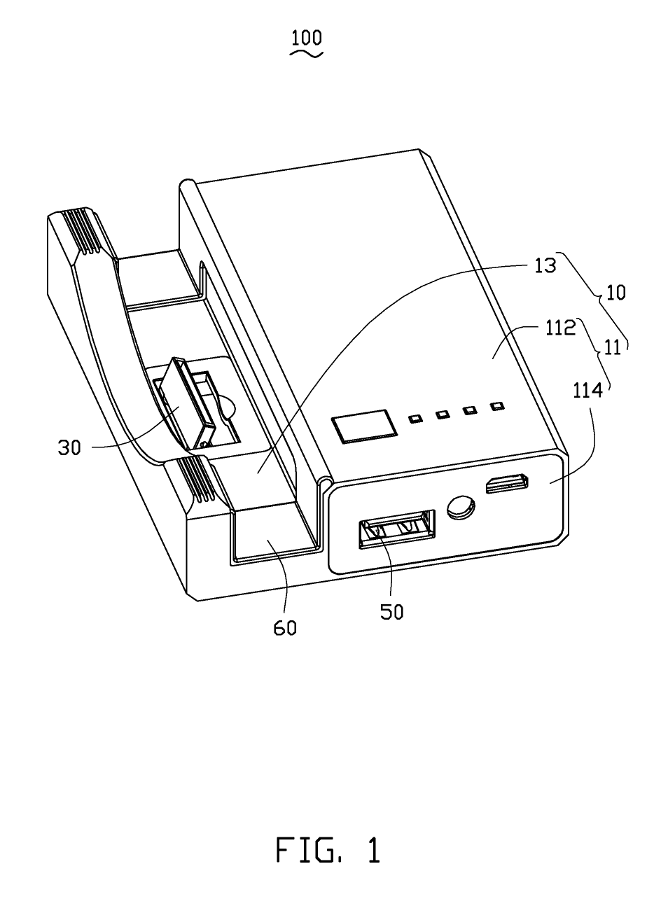

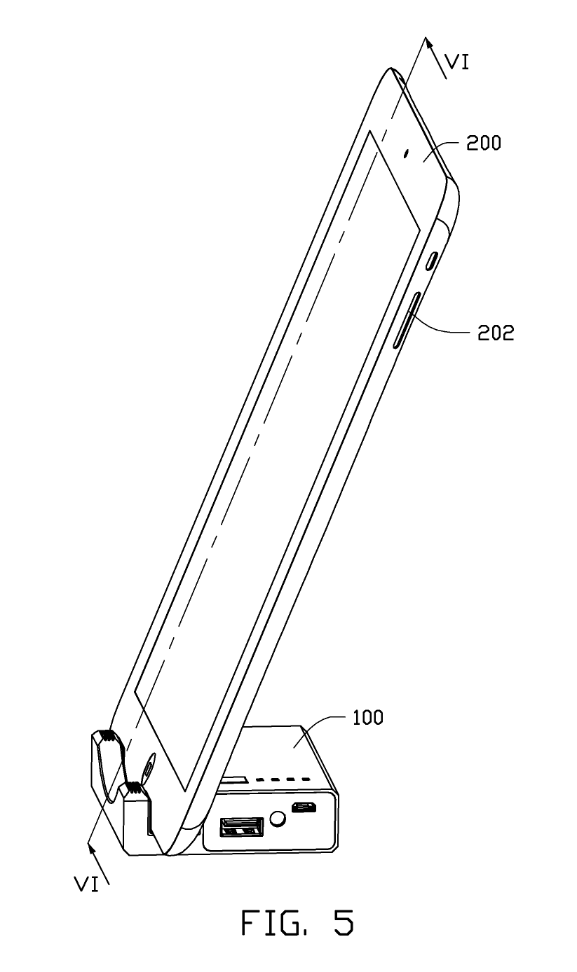

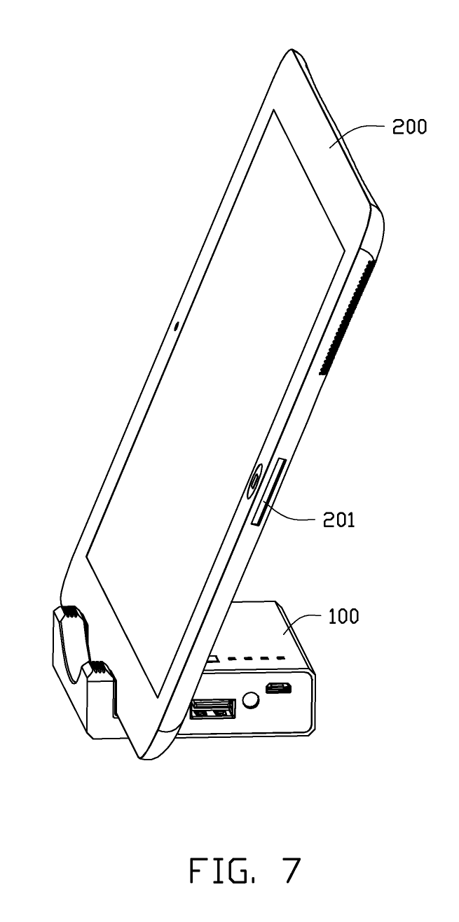

FIG. 1 shows an embodiment of a portable charger 100. FIGS. 5 and 7 show the portable charger 100 charging portable electronic devices 200, such as mobile phones and tablet computers. In the illustrated embodiment, a tablet computer is charged by the portable charger 100. A universal serial bus (USB) interface 201 and other interfaces (not labeled) are on a periphery of the electronic device 200.

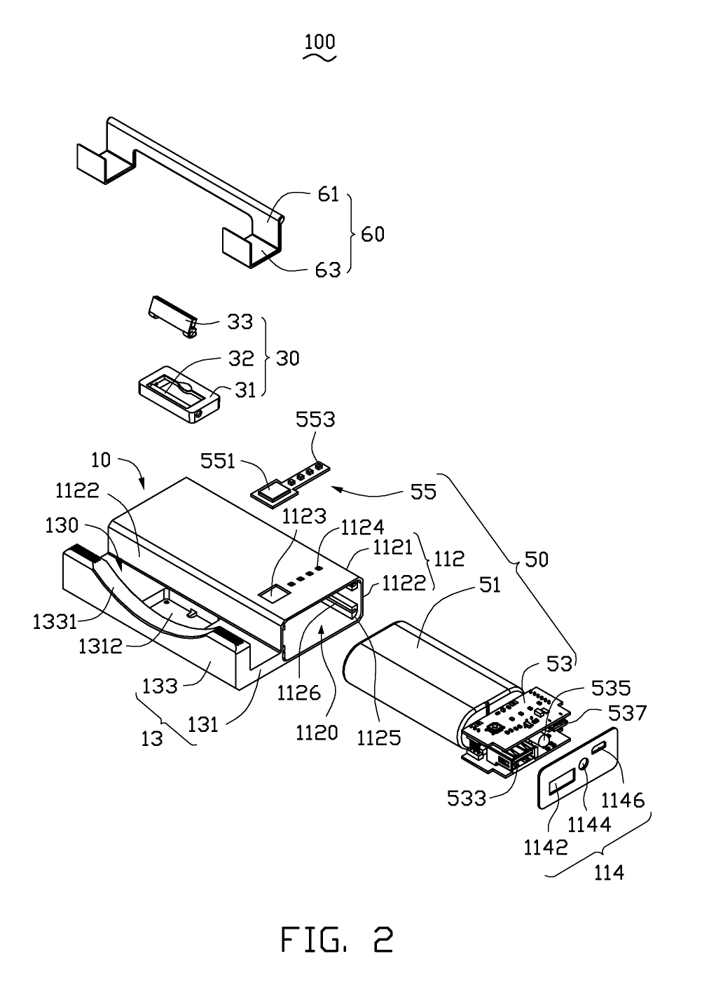

FIG. 2 shows that the portable charger 100 includes a main body 10, an electrically connecting mechanism 30, and a charging module 50. The electrically connecting mechanism 30 is mounted on the main body 10 for electrically connecting the portable charger 100 to the electronic device 200. The charging module 50 is mounted in the main body 10 and electrically connected to the electrically connecting mechanism 30.

The main body 10 includes a receiving body 11 and a support seat 13 extending from one side of the receiving body 11 and bent substantially perpendicularly. The receiving body 11 includes a casing 112 and a cover 114. The casing 112 is substantially rectangular and hollow, and defines an opening 1120. The casing 112 includes a top wall 1121 and two sidewalls 1122 substantially perpendicularly extending from two sides of the top wall 1121 respectively. A power hole 1123 and a plurality of indicating holes 1124 are defined in the top wall 1121 adjacent to the opening 1120. The casing 112 further includes two rails 1125. Each rail 1125 is mounted inside of one sidewall 1122. A sliding groove 1126 is longitudinally defined in each rail 1125. The cover 114 covers the opening 1120 of the casing 112, and defines a USB connecting hole 1142, a light hole 1144, and a charging connecting hole 1146.

The support seat 13 is substantially L-shaped, and is connected to one sidewall 1122 of the casing 11. The support seat 13 includes a support portion 131 and a blocking portion 133 substantially perpendicular and connected to the support portion 131. The support portion 131, the blocking portion 133, and the sidewall 1122 adjacent to the support portion 131 cooperatively define a receiving space 130 for receiving the electronic device 200. A mounting groove 1312 is defined in a substantially middle portion of the support portion 131. An operation groove 1331 is defined in a substantially middle portion of the blocking portion 133.

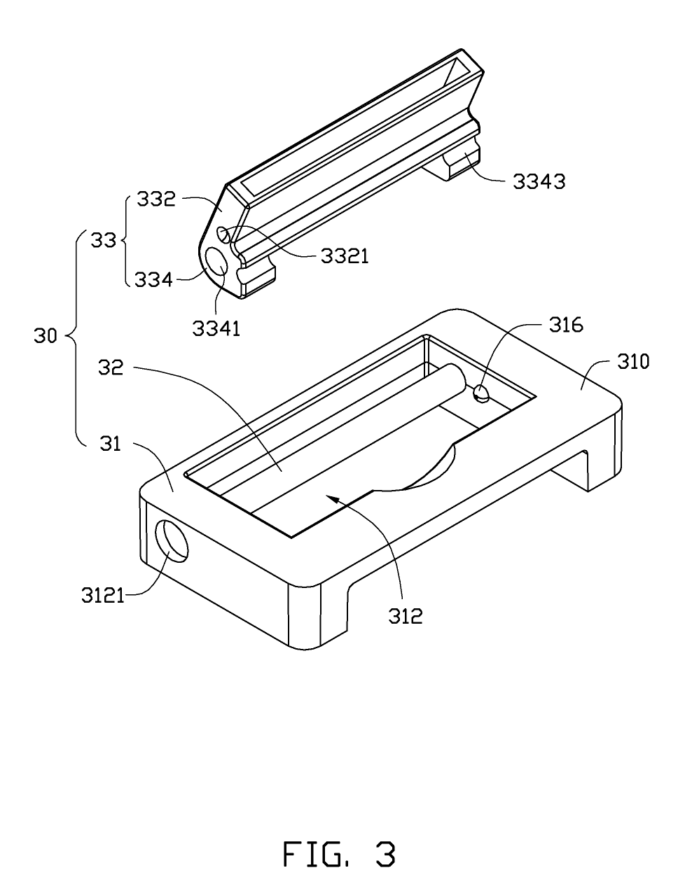

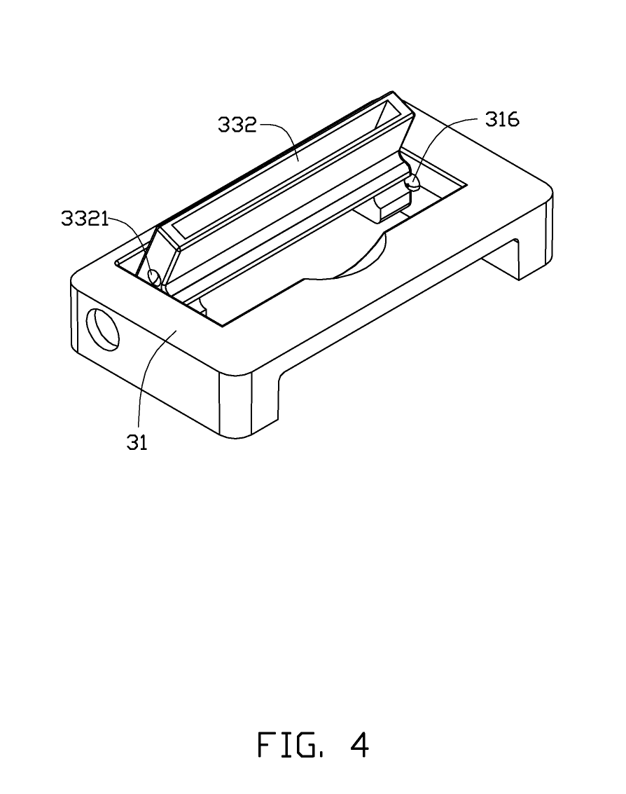

FIGS. 3 and 4 show that the electrically connecting mechanism 30 includes a fixing seat 31, a rotation shaft 32, and a connecting member 33. The fixing seat 31 is a substantially rectangular block, and is securely mounted in the mounting groove 1312. The fixing seat 31 includes a body portion 310 and two positioning protrusions 316. A receiving groove 312 is defined through the body portion 310. Opposite sidewalls of the receiving groove 312 each define a through hole 3121. Each of the positioning protrusions 316 is telescoped adjacent to one through hole 3121. In the illustrated embodiment, the positioning protrusion 316 is substantially sphere-like. The rotation shaft 32 is substantially cylindrical. Opposite ends of the rotation shaft each are mounted in one corresponding through hole 3121.

The connecting member 33 includes a connecting portion 332 and two hinged portions 334 formed on opposite sides of one end of the connecting portion 332. The connecting portion 332 is engaged with the USB interface 201 of the electronic device 200 (referring to FIG. 7). Each hinged portion 334 defines a hinged hole 3341. The connecting member 33 is hinged with the fixing seat 31 by the rotation shaft 32 passing through the hinged holes 3341. Opposite sidewalls of the connecting portion 332 each define a positioning groove 3321. The positioning groove 3321 is engaged with the positioning protrusion 316 to position the connecting member 33 in the receiving groove 312. Each hinged portion 334 further defines a limiting groove 3343. When the connecting member 33 protrudes out from the receiving groove 312, the limiting groove 3343 is engaged with the positioning protrusion 316, such that the connecting member 33 is positioned inclined relative to the fixing seat 31.

The charging module 50 is received in the receiving body 11, and includes a storage member 51, a circuit assembly 53, and a control board 55. The storage member 51 is received in the casing 112 of the receiving body 11, and is electrically connected to the circuit assembly 53 and the connecting member 33. The circuit assembly 53 is connected to the cover 114. The control board 55 is electrically mounted on the circuit assembly 53.

The circuit assembly 53 is received in the casing 112, and includes a USB interface 533, an emergency light 535, and a charging interface 537. When the USB interface 201 of the electronic device 200 is electrically connected to the connecting member 33, and the USB interface 533 of the circuit assembly 53 is electrically connected to a fixed power source (not shown) by a USB line (not shown), the electronic device 200 is charged. The storage member 51 is capable of supplying electrical energy to the emergency light 535. When the charging interface 537 is electrically connected to the fixed power source through a power line (not shown), the storage member 51 is charged. A control button 551 and a plurality of indicating lights 553 are mounted on the control board 55. The control button 551 protrudes out from the power hole 1123 to control the emergency light 535. The indicating lights 553 each protrude out from one indicating holes 1124 to indicate a charging state.

The portable charger 100 further includes an anti-skid pad 60 to prevent the electronic device 200 from skidding from the main body 10. The anti-skid pad 60 includes a base portion 61 and an anti-skid portion 63 extending from opposite ends of the base portion 61 and bent substantially perpendicularly toward one side. The base portion 61 is adhered to the sidewall 1122 of the casing 112 connected to the support seat 13. The anti-skid portion 63 is adhered to the support portion 131 around the mounting groove 1312.

In assembly, first, the storage member 51 is electrically connected to the circuit assembly 53, the control board 55 is mounted on the circuit assembly 53, and then the storage member 51 installed with the circuit assembly 53 and the control board 55 slides into the receiving body 11 along the rails 1125, and edges of the circuit assembly 53 are received in the sliding grooves 1126; second, the cover 114 is mounted on the receiving body 11; third, the fixing seat 31 is mounted in the mounting groove 1312, and is electrically connected to the storage member 51; then, the connecting member 33 is hinged to the fixing seat 31 by the rotation shaft 32; and last, the anti-skid pad 60 is adhered to the support seat 13.

FIGS. 5 and 7 show that in use, the connecting member 33 is rotated out from the receiving groove 312, and the limiting protrusions 316 are engaged in the limiting grooves 3343, such that the connecting member 33 is inclined relative to the support seat 13. If the fixed power source is available, the USB interface 201 of the electronic device 200 is electrically connected to the connecting member 33, and the USB interface 533 of the 53 is electrically connected to the fixed power source by the USB line, such that the electronic device 200 is charged by the fixed power source. If the fixed power source is not available, the electronic device 200 is charged directly by the charging module 50. When in a free time, the connecting member 33 is rotated in the receiving groove 312, and the limiting protrusions 316 are engaged in the limiting grooves 3321 to secure the connecting member 33. In addition, the portable charger 100 can be used as a support mechanism to support the electronic device 200 (referring to FIG. 7).

The portable charger 100 has a simple structure. The storage member 51 can reserve electrical energy, such that even if the fixed power source is not available, the electronic device 200 can be charged. The connecting member 33 is rotatably mounted on the support seat 13, thereby preventing the connecting member 33 from damage.

In other embodiments, the fixing seat 31 and the rotation shaft 32 can be omitted, and the connecting member 33 is directly and movably mounted on the support seat 13. A quantity of the interfaces of the circuit assembly 53 can be changed as needed. A quantity of the hinged portions 334 can be changed as needed.

It is to be understood, however, that even through numerous characteristics and advantages of the disclosure have been set forth in the foregoing description, together with details of the structure and function of the embodiments, the disclosure is illustrative only, and changes may be made in detail, especially in matters of shape, size, and arrangement of parts within the principles of the embodiments to the full extent indicated by the broad general meaning of the terms in which the appended claims are expressed.

What is claimed is:

1. A portable charger, comprising:
a main body comprising a receiving body and a support seat extending from one side of the receiving body and bent substantially perpendicularly from the receiving body;
an electrically connecting mechanism comprising a connecting member, the connecting member being movably mounted on the support seat; and
a charging module comprising a storage member received in the receiving body and at least one interface electrically connected to the storage member, wherein the storage member is electrically connected to the connecting member.

2. The portable charger of claim 1, wherein the electrically connecting mechanism further comprises a fixing seat, the fixing seat is securely mounted on the support seat, the connecting member is hinged on the fixing seat.

3. The portable charger of claim 2, wherein the connecting member comprises a connecting portion and two hinged portions oppositely formed on the connecting portion, the electrically connecting mechanism further comprises a rotation shaft, each of the two hinged portions is hinged to the fixing seat through the rotation shaft.

4. The portable charger of claim 3, wherein the fixing seat comprises a body portion, a receiving groove is defined in the body portion forming sidewalls opposite o each other, each of the sidewalls defines a through hole, each ends of the rotation shaft is mounted in each of the through hole.

5. The portable charger of claim 4, wherein the fixing seat further comprises two positioning protrusions, each of the two positioning protrusions being formed on each of the sidewalls of the body portion, each of the two positioning protrusions is telescoped adjacent to the through hole.

6. The portable charger of claim 5, wherein each of the two hinged portions defines an limiting groove, when the connecting member protrudes out from the receiving groove, the limiting groove is engaged with the positioning protrusions to position the connecting member to be inclined relative to the fixing seat.

7. The portable charger of claim 5, wherein each of the two hinged portions defines a positioning groove, the positioning groove is engaged with one of the positioning protrusions to position the connecting member in the receiving groove.

8. The portable charger of claim 2, wherein the support seat comprises a support portion and a blocking portion substantially perpendicular and connected to the support portion, the support portion, the blocking portion, and the sidewalls of the receiving body cooperatively define a receiving space, a mounting groove is defined in a substantially middle portion of the support portion, and the fixing seat is securely mounted in the mounting groove.

9. The portable charger of claim 2, wherein the receiving body comprises a casing, the charging module is received in the casing.

10. The portable charger of claim 9, wherein the casing comprises a top wall and two sidewalls substantially perpendicularly extending from two sides of the top wall respectively, a power hole and a plurality of indicating holes are defined in the top wall adjacent to one end thereof, the charging module comprises a control board, a control button, and a plurality of indicating lights, the control button and the plurality of indicating lights are mounted on the control board and protrude out from the power hole and the indicating hole, respectively.

11. The portable charger of claim 9, wherein the charging module further comprises a storage member and a circuit assembly received in the casing, the storage member is received in the casing and is electrically connected to the circuit assembly and the connecting member, the control board is mounted on the circuit assembly.

12. The portable charger of claim 10, wherein the casing further comprises two rails, each of the two rails is mounted inside of one of the two sidewalls of the casing, a sliding groove is longitudinally defined in each of the two rails, and edges of the circuit assembly each are received in the sliding groove.

13. The portable charger of claim 1, wherein the portable charger further comprises an anti-skid pad, the anti-skid pad comprises a base portion and an anti-skid portion extending from opposite ends of the base portion and bent substantially perpendicularly, the base portion is adhered to one sidewall of the casing, the anti-skid portion is adhered to the support portion.

14. A portable charger for charging an electronic device, comprising:
a main body comprising a receiving body and a support seat extending from one side of the receiving body and bent substantially perpendicularly from the receiving body;
an electrically connecting mechanism comprising a connecting member and a fixing seat hinged to the connecting member, the connecting member being movably mounted on the support seat for electrically connecting to the electronic device, the fixing seat being securely mounted on the support seat; and
a charging module comprising a storage member received in the receiving body and at least one interface electrically connected to the storage member, wherein the storage member is electrically connected to the connecting member, and the at least one interface is used for charging the electronic device or the storage member.

15. The portable charger of claim 14, wherein the connecting member comprises a connecting portion and two hinged portions oppositely formed on the connecting portion, the electrically connecting mechanism further comprises a rotation shaft, each of the two hinged portions is hinged to the fixing seat through the rotation shaft.

16. The portable charger of claim 14, wherein the support seat comprises a support portion and a blocking portion substantially perpendicular and connected to the support portion, the support portion, the blocking portion, and the sidewall of the receiving body cooperatively define a receiving space, a mounting groove is defined in a substantially middle portion of the support portion, and the fixing seat is securely mounted in the mounting groove.

17. The portable charger of claim 14, wherein the receiving body comprises a casing, the charging module is received in the casing.

18. The portable charger of claim 14, wherein the portable charger further comprises an anti-skid pad, the anti-skid pad comprises a base portion and an anti-skid portion extending from opposite ends of the base portion and bent substantially perpendicularly, the base portion is adhered to one sidewall of the casing, the anti-skid portion is adhered to the support portion.
